(19) United States
(12) Patent Application Publication
(10) Pub. No.: US 2012/0014798 A1
(43) Pub. Date: Jan. 19, 2012

(54) ENERGY PRODUCTION PLANT, IN PARTICULAR WIND POWER STATION

(76) Inventor: Gerald Hehenberger, Klagenfurt (AT)

(21) Appl. No.: 13/258,217

(22) PCT Filed: Mar. 25, 2010
(86) PCT No.: PCT/AT2010/000086

§ 371 Date: Oct. 5, 2011

(30) Foreign Application Priority Data
Mar. 26, 2009 (AT) A 489/2009

(51) Int. Cl. F03D 11/02

(52) U.S. Cl. 416/170 R

(57) ABSTRACT

An energy production plant, in particular a wind power station, includes a drive shaft, a generator (8) and a differential transmission (11-13) with three input element or output elements. A first input element is connected to the drive shaft, an output element is connected to a generator (8) and a second input element is connected to a differential drive (6). The differential transmission (11 to 13) is a planetary gear set with planetary wheels (19). The planetary wheels (19) respectively include two toothed wheels which are rotationally connected together and have different reference diameters.

The invention relates to an energy production plant, in particular a wind power station, with a drive shaft, with a generator and with a differential gear with three drives and outputs, a first drive being connected to the drive shaft, one output with a generator and a second drive with an electrical differential drive, the differential gear being a planetary gearing system with planetary gears.

Wind power stations are becoming increasingly important as power generation plants. In this way, the percentage of power generation by wind is continuously increasing. This in turn dictates, on the one hand, new standards with respect to current quality and, on the other hand, a trend toward still larger wind power stations. At the same time, a trend toward offshore wind power stations is recognizable that requires station sizes of at least 5 MW installed power. Due to the high costs for infrastructure and maintenance or servicing of wind power stations in the offshore region, here both efficiency and also production costs of the stations with the associated use of medium voltage synchronous generators acquire special importance.

WO2004/109157 A1 shows a complex hydrostatic “multipath” concept with several parallel differential stages and several switchable clutches, as a result of which it is possible to switch between the individual paths. With the illustrated technical design, the power and thus the losses of the hydrostatics can be reduced. One major disadvantage is, however, the complicated structure of the entire unit. Moreover, the switching between the individual stages constitutes a problem in the control of the wind power station.

EP 1283359 A1 shows a 1-stage and a multistage differential gear with an electrical differential drive, the 1-stage version having a special three-phase machine that is positioned coaxially around the input shaft with high nominal speed that as a result of the design has a mass moment of inertia that is extremely high relative to the rotor shaft. Alternatively, a multistage differential gear with a high speed standard three-phase machine is proposed that is aligned parallel to the input shaft of the differential gear.

These technical designs allow the direct connection of medium voltage synchronous generators to the grid (i.e., without using frequency converters); the disadvantages of known embodiments are, however, on the one hand, high losses in the differential drive, and, on the other hand, for concepts that solve this problem, complex mechanisms or special electrical machine construction and thus high costs. In general, it can be maintained that cost-relevant criteria, such as, for example, optimum control and size of the differential drive, have not been adequately considered.

The object of the invention is to largely avoid the aforementioned disadvantages and to make available an energy production plant that in addition to the lowest possible costs also ensures minimum overall size of the differential drive.

This object is achieved according to the invention in that the planetary gears have two gears each that are connected in a torque-proof manner to one another and that have different pitch circle diameters.

In this way, a very compact and efficient construction of the plant is possible, with which, moreover, the control engineering aspects for the energy production plant, especially the wind power station, are optimally resolved.

Preferred embodiments of the invention are the subject matter of the other dependent claims.

Preferred embodiments of the invention are described in detail below with reference to the attached drawings.

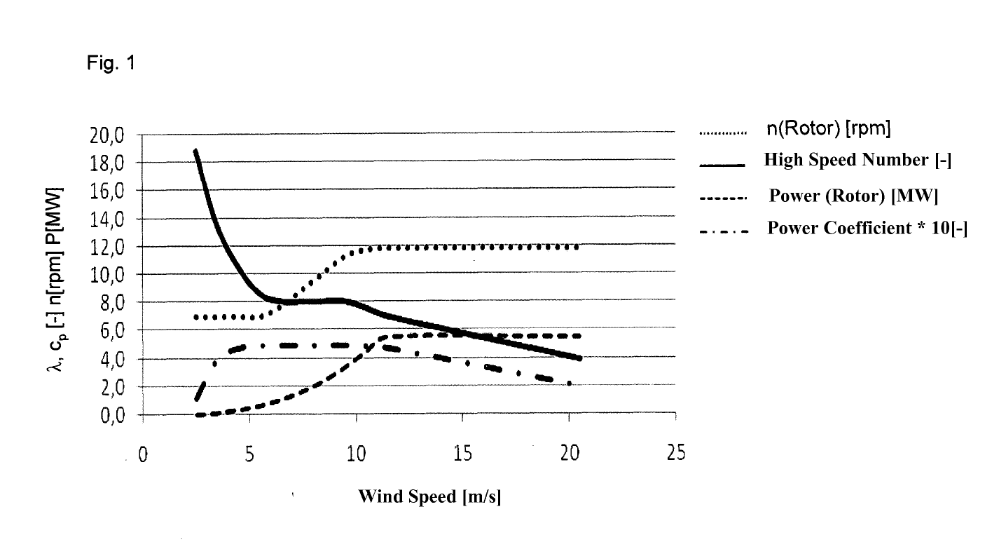

For a 5 MW wind power station according to the state of the art, FIG. 1 shows the power curve, the rotor speed and the resulting characteristics such as the high speed number and the power coefficient,

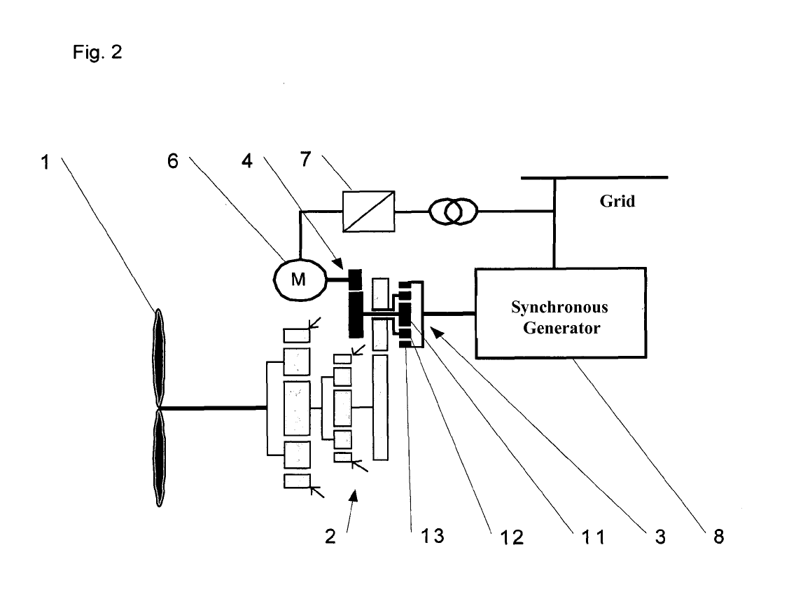

FIG. 2 shows the principle of a differential gear with an electrical differential drive according to the state of the art,

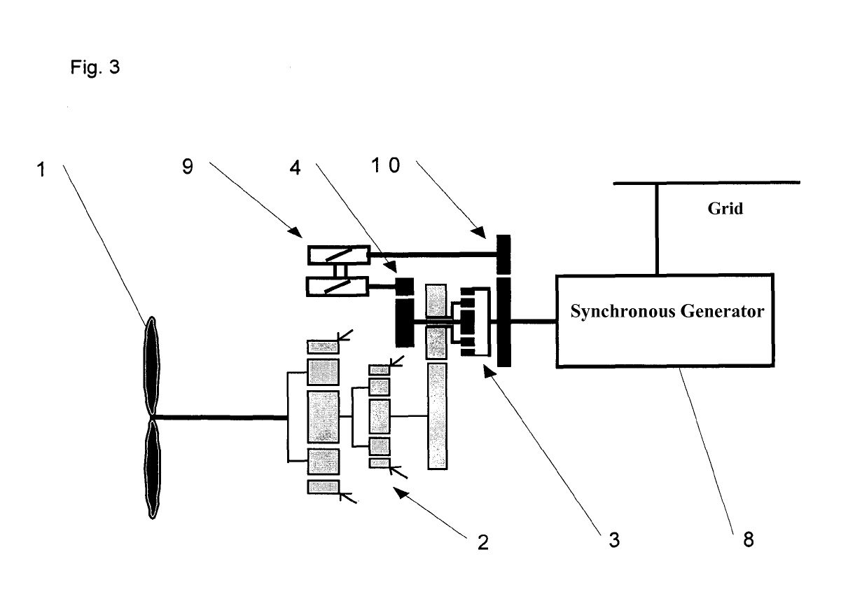

FIG. 3 shows the principle of a hydrostatic differential drive with a pumps/motor combination according to the state of the art,

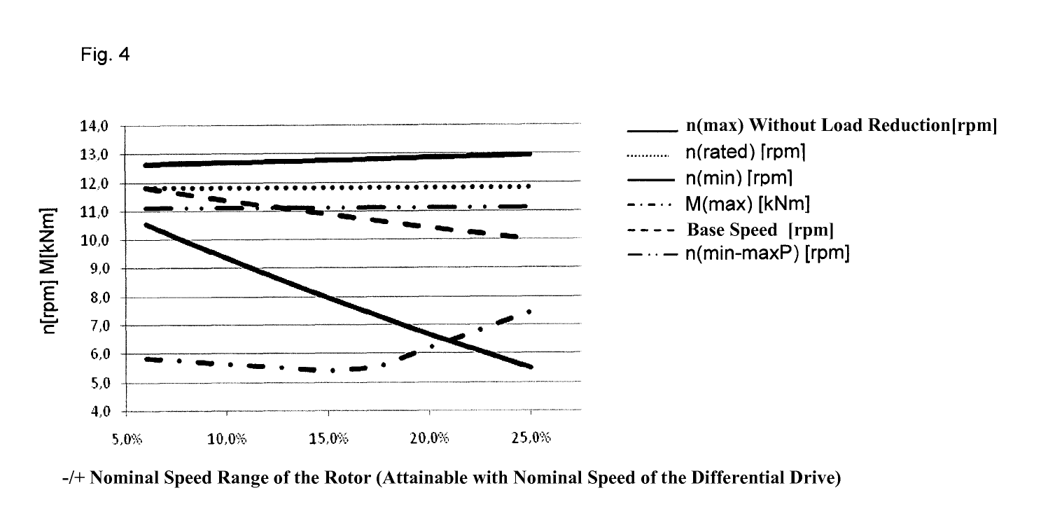

FIG. 4 shows the speed ratios on the rotor of the wind power station and the resulting maximum input torques Mₘₐₓ for the differential drive,

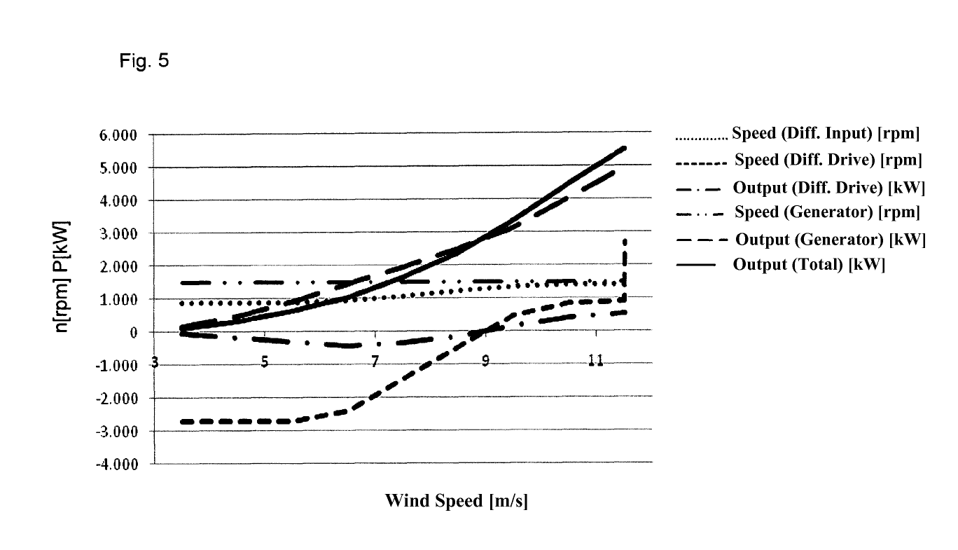

FIG. 5 shows—by way of example according to the state of the art—the speed and power ratios of an electric differential drive over the wind speed,

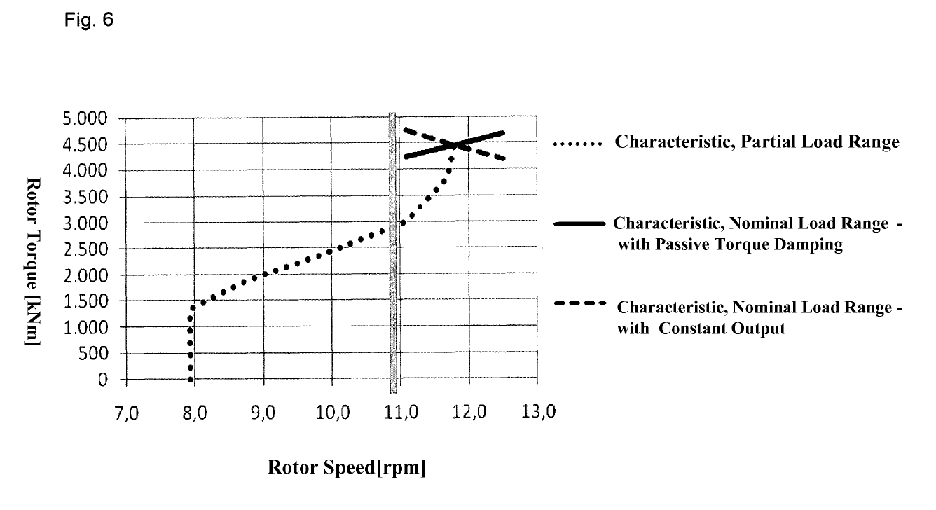

FIG. 6 shows the torque/speed characteristic of a differential drive in the partial load range and in the nominal load range for two different operating modes,

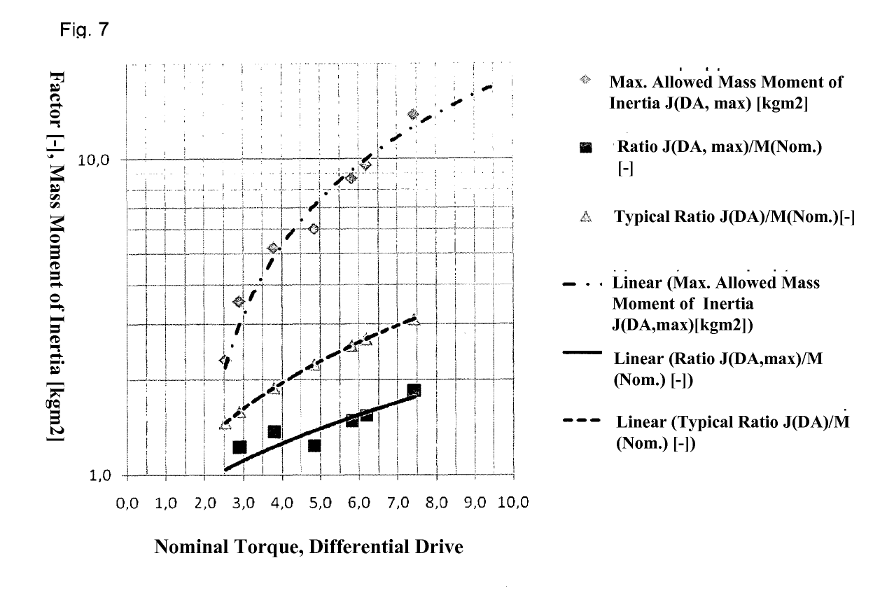

FIG. 7 shows the maximum allowed mass moment of inertia of the differential drive for an application factor of f_{A}=0.2 and the comparison of the typical ratio of the mass moment of inertia to the nominal torque of highly dynamic servo drives according to the state of the art and differential drives according to this invention,

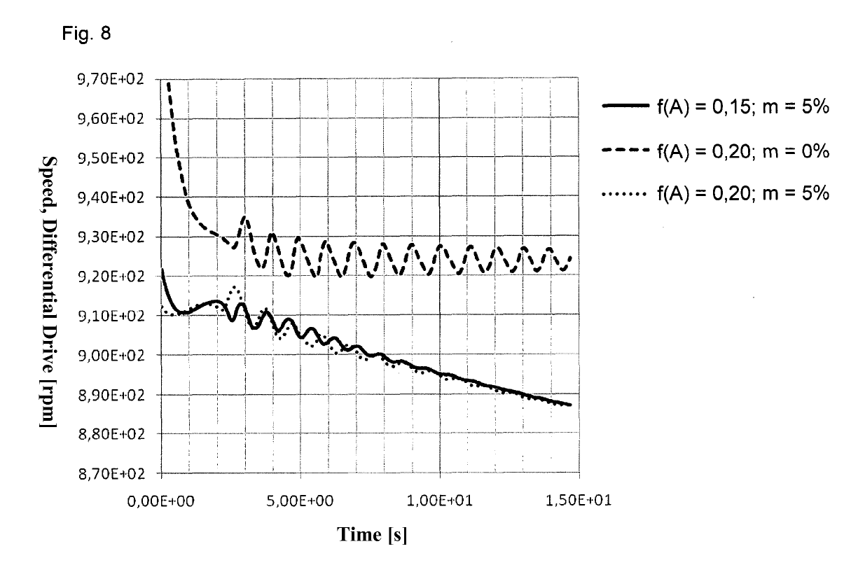

FIG. 8 shows the effect of the mass moment of inertia of the differential drive and the slope of the torque characteristics on the control behavior of the wind power station,

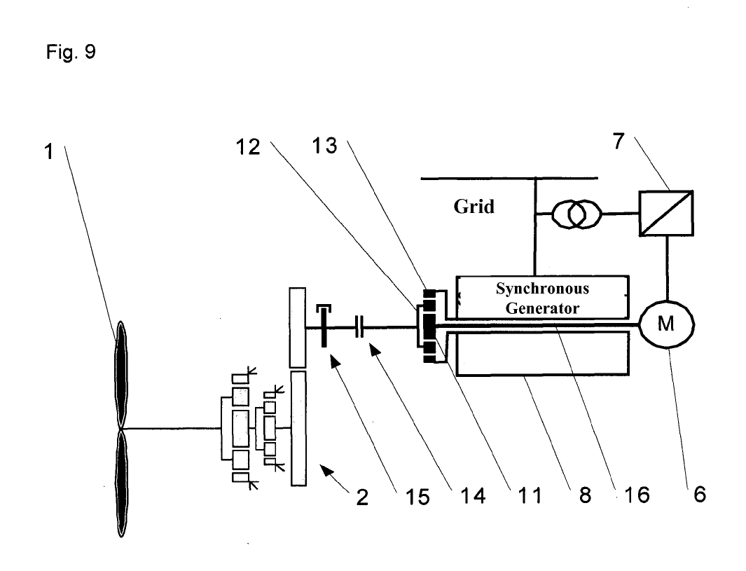

FIG. 9 shows one possible variant embodiment of a differential stage in conjunction with this invention,

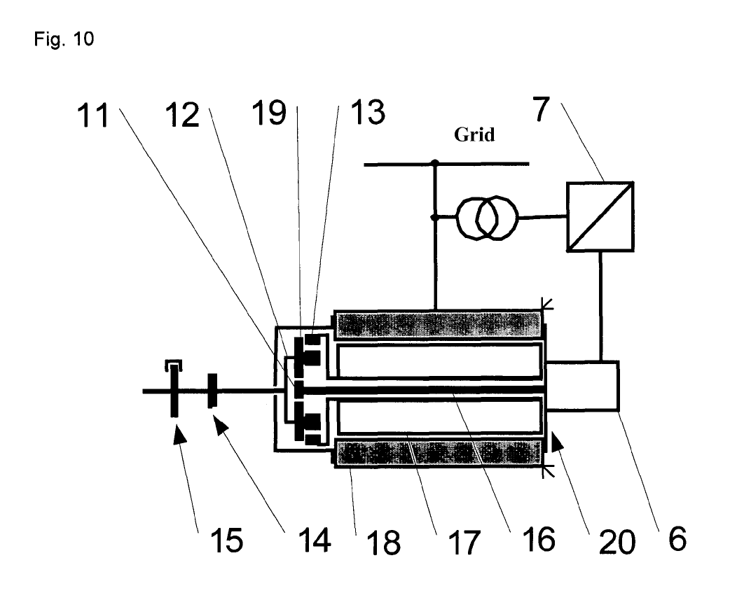

FIG. 10 shows one variant of a differential stage according to the invention with stepped planetary gear.

The output of the rotor of a wind power station is computed from the following formula:

Rotor output=rotor area*power coefficient*wind speed³*air density/2

the power coefficient being dependent on the high speed number (=ratio of blade tip speed to wind speed) of the rotor of the wind power station. The rotor of a wind power station is designed for an optimum power coefficient based on a high speed number that is to be established in the course of development (in most cases, a value of between 7 and 9). For this reason, in the operation of the wind power station in the partial load range, a correspondingly small speed can be set to ensure optimum aerodynamic efficiency.

FIG. 1 shows the ratios for rotor output, rotor speed, high speed number and power coefficient for a given maximum speed range of the rotor and an optimum high speed number of 8.0˜8.5. It is apparent from the diagram that as soon as the high speed number deviates from its optimum value of 8.0˜8.5, the power coefficient drops and thus according to the aforementioned formula, the rotor output is reduced according to the aerodynamic characteristic of the rotor.

FIG. 2 shows one possible principle of a differential system for a wind power station consisting of differential stages 3 and 11 to 13, a matching gear stage 4, and an electrical differential drive 6. The rotor 1 of the wind power station that sits on the drive shaft of the main gear 2 drives the main gear 2. The main gear 2 is a 3-stage gear with two planetary gear stages and one spur gear stage. Between the main gear 2 and the generator 8, there is a differential stage 3 that is driven by the main gear 2 via planetary gear carriers 12 of the differential stage 3. The generator 8—preferably a separately excited synchronous generator that if necessary can also have a nominal voltage of greater than 20 kV—is connected to the ring gear 13 of the differential stage 3 and is driven by it. The pinion 11 of the differential stage 3 is connected to the differential drive 6.

The speed of the differential drive 6 is controlled in order, on the one hand, to ensure a constant speed of the generator 8 at variable speed of the rotor 1 and, on the other hand, to control the torque in the complete drive line of the wind power station. In order to increase the input speed for the differential drive 6, in the illustrated case, a 2-stage differential gear is chosen that calls for a matching gear stage 4 in the form of a spur gear stage between the differential stage 3 and differential drive 6. The differential stage 3 and matching gear stage 4 thus form the 2-stage differential gear. The differential drive is a three-phase machine that is connected to the grid via frequency converter 7 and transformer 5. Alternatively, the differential drive, as is shown in FIG. 3, can also be made as, for example, a hydrostatic pumps/motor combination 9. In this case, the second pump is preferably connected to the drive shaft of the generator 8 via the matching gear stage 10.

The speed equation for the differential gear is as follows:

speed_{Generator}=x*speed_{Rotor}+y*speed_{Differential drive}

the generator speed being constant, and the factors x and y can be derived from the selected gear transmission ratios of the main gear and differential gear.

The torque on the rotor is determined by the prevailing wind and the aerodynamic efficiency of the rotor. The ratio between the torque on the rotor shaft and that on the differential drive is constant, as a result of which the torque in the drive line can be controlled by the differential drive. The torque equation for the differential drive is as follows:

torque_{Differential drive}=torque_{Rotor}*y/x,

the size factor y/x being a measure of the necessary design torque of the differential drive.

The output of the differential drive is essentially proportional to the product of the percentage deviation of the rotor speed from its base speed times the rotor output. Accordingly, a large speed range requires essentially a correspondingly large dimensioning of the differential drive. In electric and hydrostatic differential drives with a differential stage, the base speed is that speed of the rotor at which the differential drive is stationary, i.e., has speed equal to zero.

FIG. 4 shows this according to the state of the art, for example for various speed ranges. The −/+ nominal speed range of the rotor defines its percentage speed deviation from the base speed of the rotor that with the nominal speed of the differential drive (− . . . as motor and + . . . as generator) can be accomplished without field attenuation. The nominal speed (n) of the differential drive in the case of an electrical three-phase machine defines that maximum speed at which it can continuously deliver the nominal speed (Mₙ) or the nominal power (Pₙ).

In the case of a hydrostatic drive, such as, for example, a hydraulic axial piston pump, the nominal speed of the differential drive is that speed at which it can deliver maximum continuous power (P_{0 max}) with maximum torque (Tₘₐₓ). Here, the nominal pressure (ρ_{N}) and nominal size (NG) or displacement volume (V_{g max}) of the pump determine the maximum torque (Tₘₐₓ).

In the nominal output range, the rotor of the wind power station turns with an average speed n_{rated} between the limits nₘₐₓ and n_{min-maxP} in the partial load range of between n_{rated} and nₘᵢₙ, in this example attainable with a field attenuation range of 80%. The control speed range of between nₘₐₓ and n_{min-maxP} that can be accomplished without load reduction is chosen to be accordingly large, in order to be able to compensate for wind gusts. The size of this speed range depends on the gustiness of the wind and the mass inertia of the rotor of the wind power station and the dynamics of the so-called pitch system (rotor blade adjustment system) and is conventionally approximately −/+5%. In the illustrated example, a control speed range of −/+6% was chosen to have corresponding reserves for the compensation of extreme gusts using differential drives. Wind power stations with very inert pitch systems can, however, also be designed for larger control speed ranges. In this control speed range, the wind power station must produce nominal output; this means that the differential drive is loaded here with maximum torque. This means that the −/+ nominal speed range of the rotor must be roughly the same since only in this range can the differential drive deliver its nominal torque.

Since at this point for small rotor speed ranges, the base speed is above n_{min-maxP}, the differential drive must be able to deliver the nominal torque at a speed equal to zero. Differential drives, whether electrical or also hydraulic, are, however, for a speed equal to zero, designed only for the so-called static torque that is distinctly below the nominal torque; this, however, can be compensated by a corresponding overdimensioning in the design. Since, however, the maximum design torque is the dimensioning factor for a differential drive, for this reason a small speed range positively affects the size of the differential drive to only a limited degree. This is also recognized on the curve Mₘₐₓ that constitutes the torque of the differential drive that is to be maximally delivered depending on the nominal speed range. The basis for this is the use of a single-stage differential gear with an assumed maximum static transmission ratio of i_{0z}=−6, constant power control in the nominal load range, and a 4-pole synchronous generator with a synchronous speed of 1500 min⁻¹.

FIG. 5 shows by way of example the speed or power ratios for a differential stage according to the state of the art. The speed of the generator, preferably a separately excited medium voltage synchronous generator, is constant due to the connection to the frequency-fixed power grid. In order to be able to use the differential drive correspondingly well, this drive is operated as a motor in the range that is smaller than the base speed and as a generator in the range that is greater than the base speed. This leads to the power being fed into the differential stage in the motor range and power being taken from the differential stage in the generator range. In the case of an electrical differential drive, this power is preferably taken from the grid or fed into it. In the case of a hydraulic differential drive, the power is preferably taken from the generator shaft or supplied to it. The sum of the generator power and power of the differential drive yields the total power delivered into the grid for a wind power station with an electrical differential drive.

One essential advantage for electrical and hydrostatic differential drives is the free adjustability of the torque and/or speed. Thus, for example, by means of programmable control, different control methods can be implemented or they can also be optionally matched to changing ambient or operating conditions as required during operation of the station.

FIG. 6 shows the characteristic for the rotor torque depending on the rotor speed for a wind power station with a differential drive with −/+15% nominal speed range. Here, different operating regions or operating modes are shown. The dotted line shows the ratios in the partial load range of the station. The broken line shows a characteristic that is typical according to the state of the art for constant power control in the nominal load range. The third line according to the invention shows the torques for so-called progressive torque control. Here, for the nominal load range, a characteristic with a rotor torque that rises with the rotor speed is set and in the illustrated example has a torque slope of m=5%. The value for the torque slope (m) is computed from the percentage slope of the rotor torque between the rotor nominal speed and max. rotor speed of the control speed range. For the sake of completeness, it can be mentioned here that any other optional characteristic for the torque slope can also be set, and it can be adapted to the ambient and/or operating conditions in operation. For applications with a nominal speed range of greater than −/+15%, a reduced torque slope of, for example, m=3% yields good results; for applications with a very small nominal speed range, a torque slope of m=10% can be recommended.

Since, for the differential drive, there is a constant ratio between the rotor torque and torque on the differential drive, for the differential drive the same conditions apply as for the rotor. At first glance, with reference to the maximum necessary torque, there does not seem to be any significant difference between the two types of control in the nominal load range. In FIG. 6, a vertical line is inserted at 10.9 min⁻¹ that marks the base speed of the rotor. Differential drives, whether electrical or else hydraulic, can, however, as already mentioned above, at a speed equal to zero, only produce the static torque that is distinctly below the nominal torque. In order to be able to deliver the nominal torque in the region of the speed equal to zero, therefore, the differential drive must be overdimensioned by roughly 25%. This value decreases with increasing distance of the speed of the differential drive from the speed equal to zero. In the illustrated case according to FIG. 6, this means that the required design torque of the differential drive for the minimum rotor speed in the control speed range must be roughly 10% above the required drive torque. Since, however, in the illustrated example, the torque slope over the entire control speed range is likewise 10% (−/+5%), for the differential drive for both corner points of the control speed range, the required design torque is the same.

Conversely, for the illustrated control speed range of −/+6% and for nominal load control with constant power, the design torque required for the differential drive is roughly 11% higher than for progressive torque control. This in turn leads to higher costs and a larger mass moment of inertia for the differential drive with a major disadvantage with reference to the attainable control dynamics.

The illustrated effect is amplified with the nominal speed range becoming smaller, with a maximum effect for a nominal speed range of roughly −/+12.5%. For nominal speed ranges of greater than −/+20%, hardly more than one advantage in this respect can be recognized.

Another advantage of the progressive torque control is the resulting effect of passive torque damping. A wind power station is a dynamically extremely complex machine. This results in that in the drive line, different frequencies are being continuously excited and have adverse effects on current quality and loading of the entire wind power station. According to the state of the art, it is therefore conventional to implement so-called active drive line damping that works, for example, as follows. In the drive line, the torque and/or the speed are measured. Then, the measurement signal is filtered, and a corresponding value that counteracts the unwanted oscillations is superimposed on the torque setpoint. The additional torque necessary for this purpose is conventionally in the region of up to roughly 5% of the nominal torque. If, at this point, a progressive torque control is implemented instead of the active drive line damping, it is shown that it has an effect that damps compared to the nominal load control with constant power. This applies mainly in conjunction with the compensation for speed and torque fluctuations caused by wind gusts.

At this point, FIG. 7 shows an effect that is likewise important in this connection. Fundamentally, the control behavior of a wind power station is associated very dramatically with its speed distribution s_{ges} and subsequently with the ratio of the mass moment of inertia of the rotor J_{R} and differential drive J_{DA}.

The speed distribution s_{ges} is the ratio of the speed range of the differential drive to the speed range of the rotor of the wind power station (s_{ges}=speed range differential drive/speed range rotor), the speed ranges being determined by the rotor speeds nₘᵢₙ and nₘₐₓ (compare FIG. 4) and the resulting speeds of the differential drive. Since, on the one hand, the speed distribution s_{ges} is a measure for the transmission ratio between the rotor and differential drive, and, on the other hand, the mass moment of inertia of the differential drive relative to the rotor with the transmission ratio is squared, the maximum mass moment of inertia allowed (for good control behavior of a wind power station with an electrical differential drive) for the differential drive J_{DA,max} is computed as follows:

J_{DA,max}=(J_{R}/s_{ges}²)*f_{A},

f_{A} being an application factor that is a measure for the control behavior of the wind power station. The diagrams in FIG. 7 were based on an application factor of f_{A}=0.20, with which good results with respect to the control behavior are achieved (compare also FIG. 8 in this regard). Fundamentally, it can be maintained that as f_{A} becomes smaller, still better results can be achieved, for applications with f_{A}<roughly 0.15, an additional added cost with respect to reduction of the mass of the rotor of the differential drive becoming necessary.

For different drive variants (with nominal speeds of the differential drive of 1000 min⁻, 1250 min⁻¹, and 1500 min⁻¹, rotor speed ranges of −/+10%, 15% and 20%, and wind power station nominal powers of 3 MW and 5 MW) and f_{A}=0.20, FIG. 7 shows the “maximum allowed mass moment of inertia J_{DA, max}” of the differential drive and the “ratio J_{DA, max}/Mₙₒₘ,” Mₙₒₘ being the required nominal torque of the differential drive. Furthermore, FIG. 7 shows the typical ratio of the mass moment of inertia to the nominal torque of conventional servo drives according to the state of the art (“typical ratio of J_{DA}/Mₙₒₘ”). It is unequivocally recognizable that differential drives for a relatively good control behavior of the wind power station necessitate a smaller ratio of J_{DA}/Mₙₒₘ than can be found in conventional servo drives.

FIG. 8 shows the effect of different torque slopes (m=0% and m=5%) and mass moments of inertia of the differential drive on its speed/control behavior after a “sudden power variation” of the wind power station due to, for example, a wind gust. Thus, a sudden power variation of the wind power station with a J_{DA,max}=J_{R}/s_{ges}²)*f_{A} with f_{A}=0.20 and m=0% results in that the speed of the differential drive begins to oscillate with an amplitude of initially roughly 15 min⁻¹ (that is, approximately 1.6% of the average speed being established at this instant), and this amplitude becomes smaller only slowly. Clear improvement appears already at f_{A}=0.20 and m=5%, i.e., with passive torque damping. The amplitude that is being initially established is roughly 10 min⁻¹ and decreases quickly. If, moreover, f_{A} is reduced to 0.15, an initial amplitude is roughly 5 min⁻¹ (i.e., roughly 0.6% of the average speed that is being established at this time), which likewise quickly decays. A further reduction of the application factor to, for example, f_{A}=0.10 yields another improvement that is necessary for highly dynamic applications, but is associated with strongly increasing production costs for the rotor of the differential drive, as already mentioned above. Fundamentally, it can be maintained that a station configuration with f_{A}=0.15 and m=5% yields a result that is good enough for standard applications.

It should be mentioned in addition here that a positive power slope compared to a control that is typical according to the state of the art with constant power in the nominal load range already causes an improvement with respect to the overall size of the differential drive and torque damping; this is, however, less than with a positive torque slope. Here, for the nominal load range, a characteristic with a rotor output that rises with the rotor speed is established. The value for the characteristic of the power slope is computed, in this case, from the percentage slope of the rotor output between nominal rotor speed and max. rotor speed of the control speed range.

FIG. 9 shows one possible variant embodiment of a differential stage. The rotor 1 drives the main gear 2 and the latter drives the differential stages 11 to 13 via planetary gear carriers 12. The generator 8 is connected to the ring gear 13, and the pinion 11 is connected to the differential drive 6. The differential gear is 1-stage, and the differential drive 6 is in a coaxial arrangement both to the output shaft of the main gear 2 and also to the drive shaft of the generator 8. For the generator 8, there is a hollow shaft that allows the differential drive to be positioned on the side of the generator 8 that is facing away from the differential gear. In this way, the differential stage is preferably a separate assembly that is linked to the generator 8 and that is then connected to the main gear 2 preferably via a coupling 14 and a brake 15. The connecting shaft 16 between the pinion 11 and the differential drive 6 can preferably be made in a torsionally-stiff variant embodiment that has especially little mass moment of inertia, as, for example, a fiber composite shaft with glass fibers and/or carbon fibers.

Essential advantages of the illustrated coaxial, 1-stage embodiment are (a) the mechanical simplicity and the compactness of the differential gear, (b) the resulting high efficiency of the differential gear, and (c) the comparatively low mass moment of inertia of the differential drive 6 relative to the rotor 1 due to the relatively low transmission ratio of the differential gear. Moreover, the differential gear can be made as a separate assembly and can be implemented and serviced independently of the main gear. The differential drive 6 can, of course, also be replaced by a hydrostatic drive, for which, however, a second pump element that interacts with the hydrostatic differential drive must be driven by preferably the gear output shaft that is connected to the generator 8.

If, however, the torque line Mₘₐₓ from FIG. 4 is examined in this connection, the following limitation can be recognized. When using a single-stage differential gear, the speed and accordingly the required torque for the differential drive cannot be freely chosen, but it results from the feasibly attainable static transmission ratio i_{0z} of a planetary gear stage and the synchronous speed of the generator. On the other hand, with the static transmission ratio, also the minimally attainable diameter of one planetary gear stage and accordingly also its production costs increase. In summary, it can be maintained that for differential systems with conventional, single-stage planetary gears and small nominal speed range, primarily the static transmission ratio must be chosen to be correspondingly high in order to achieve a nominal torque that is as small as possible for the differential drive. This in turn, however, dictates a transmission ratio that is unfavorably high for the main gear, as a result of which for large wind power stations with low nominal rotor speed and a high speed synchronous generator, a design with a maximum of 3 gear stages for the main gear can only be accomplished with great effort.

FIG. 10 shows the variant of a differential stage according to the invention with a stepped planetary gear. As already shown in FIG. 9, here the differential drive 6 is also driven by the pinion 11 via the connecting shaft 16. The pinion 11 is preferably simply mounted via the connecting shaft 16 in the region of the so-called ND end of the generator 20; the connecting shaft, however, can also be mounted on two bearings, for example in the generator shaft. The synchronous generator consists of a stator 18 and a rotor 17 with a finished hollow shaft that is driven by the ring gear 13. The planetary gears mounted in the planetary gear carrier 12—preferably three in number—are so-called stepped planetary gears 19. They consist of two gears that are connected in a torque-proof manner in each case with a different diameter and preferably different tooth geometry. The ring gear 13 in the illustrated example engages the gear of the stepped planetary gears 19 that is smaller in diameter, and the pinion 11 engages the second gear of the stepped planetary gears 19. Since much higher torque must be transmitted via the ring gear 13 than via the pinion 11, the tooth width for it is much larger than that for the pinion 11. The tooth widths of the stepped planetary gears 19 are also configured accordingly. For reasons of noise reduction, the tooth system of the differential gear can be made as a slanted tooth system. The resulting axial forces that must be accommodated by the support of the parts of the tooth system can be reduced by the opposite slanted position of the tooth system of the two gears of the stepped planetary gears 19, depending on the individually chosen angles of the slanted position. Preferably, the individual slant angles of the parts of the tooth systems of the stepped planetary gears are chosen such that a resulting axial force no longer acts on the support of the stepped planetary gears.

By using stepped planetary gears, there is an additional degree of freedom for the choice of the nominal speed of the differential drive without increasing the number of the tooth engagements that determine the efficiency. In this way, the base transmission ratio between the speed of the rib and that of the ring gear (is equal to the generator speed) of the planetary gear stage can be reduced, and thus the part of the differential gear bearing the main load can be produced to be much smaller and more economical without the nominal speed of the differential drive being shifted into an unfavorable region.

The following table shows the technical parameters for a conventional planetary gear stage compared to a planetary gear stage with stepped planetary gear for the differential system of a wind power station with a nominal power of 5 MW. In the illustrated example, both variants have a progressive torque control with m=5 and a nominal speed range of −/+15%. The example clearly shows the advantages of the variants with stepped planetary gear with reference to cost-defining factors such as the diameter of the ring gear and the nominal torque of the differential stage.

| | Conventional | Stepped | |
|---|---|---|---|
| | Planetary Gear | Planetary | |
| Technical Parameter | Stage | Gear | Deviation |
| Nominal Rotor Output [kW] | 5,500 | 5,500 | 0% |
| Nominal Rotor Speed [min⁻¹] | 11.8 | 11.8 | 0% |
| Minimum Rotor Speed [min⁻¹] | 7.9 | 7.9 | 0% |
| Generator Speed [min⁻¹] | 1,000 | 1,000 | 0% |
| Nominal Speed Differential | 900 | 1,500 | 67% |
| Drive [min⁻¹] | | | |
| Nominal Torque Differential | 8.5 | 5.1 | −40% |
| Drive [kNm] | | | |
| Primary Static Transmission | 6.0 | 4.7 | −22% |
| Ratio Differential Stage [—] | | | |
| Minimum Required Ring Gear | 500 | 350 | −30% |
| Diameter [mm] | | | |
| Required Transmission Ratio | 78.8 | 83.6 | 6% |
| Main Gear [—] | | | |
| Nominal Speed of Planetary | 930 | 986 | 6% |
| Gear Carrier [min⁻¹] | | | |

If, at this point, the advantages from a differential gear with stepped planetary gear and progressive torque control are summarized, compared to a station with a conventional planetary gear stage and nominal load control with constant power, there is a required nominal torque that is roughly 40% lower for the differential drive.

On the other hand, a single-stage differential gear with a stepped planetary gear results in that the nominal speed of the differential drive becomes higher; thus, it does enable a lower required nominal torque for the differential drive, but on the other hand it increases the speed distribution s_{ges}. Since at this point s_{ges} enters quadratically into the computation formula for J_{DA,max} the mass moment of inertia in the case of a standard design of the differential drive is fundamentally, however, more or less proportional to the nominal torque; for the design of the differential drive with reference to its mass moment of inertia J_{DA,max}, an application factor f_{A} that is as small as possible must be considered in order to ensure an acceptable control behavior of the wind power station.

1. Energy production plant, in particular a wind power station, with a drive shaft, with a generator (8), and with a differential gear (11 to 13) with three drives and outputs, a first drive being connected to the drive shaft, one output to a generator (8), and a second drive to a differential drive (6), the differential gear (11 to 13) being a planetary gear system with planetary gears (19), characterized in that the planetary gears (19) have two gears each that are connected in a torque-proof manner to one another and that have different pitch circle diameters.

2. Energy production plant according to claim 1, wherein the two gears have an opposite slant position of the tooth system.

3. Energy production plant according to claim 1, wherein the differential drive (6) is connected to the sun wheel (11) of the differential gear (11 to 13) and wherein the differential drive (6) is located on the side of the generator (8) facing away from the differential gear (11 to 13).

4. Energy production plant according to claim 1, wherein the differential drive (6) is located coaxially to the shaft of the generator (8).

5. Energy production plant according to claim 1, wherein it has only one differential stage (11 to 13).

6. Energy production plant according to claim 1, wherein it has a multistage differential gear (3).

7. Energy production plant according to claim 1, wherein it has a multistage differential gear (3, 4).

8. Energy production plant according to claim 1, wherein the drive shaft is the rotor shaft of a wind power station.

9. Energy production plant according to claim 1, wherein a connecting shaft (16) between the pinion (11) and the differential drive (6) is made as a fiber composite shaft.

10. Energy production plant according to claim 1, wherein the differential drive (6) is an electrical machine.

11. Energy production plant according to claim 1, wherein the differential drive (6) is a hydraulic, especially a hydrostatic, drive.

12. Energy production plant according to claim 1, wherein there is a brake (15) that acts on the drive shaft on the side of the differential gear (11 to 13) on which the first drive is located.

13. Energy production plant according to claim 1, wherein one characteristic of the rotor output for the nominal load range has a slope with the rotor speed, the value for the slope of the characteristic being computed from the percentage slope of the rotor output between the nominal rotor speed and the maximum rotor speed of a control speed range.

14. Energy production plant according to claim 1, wherein one characteristic of the rotor torque for the nominal load range has a slope with the rotor speed, the value for the slope of the characteristic being computed from the percentage slope of the rotor torque between the nominal rotor speed and the maximum rotor speed of a control speed range.

15. Energy production plant according to claim 14, wherein the slope of the characteristic of the rotor torque is at least 3%, preferably at least 5%, and especially at least 10%.

16. Energy production plant according to claim 1, wherein the maximum mass moment of inertia of the electrical differential drive is J_{DA,max}=(J_{R}/s_{ges}²)*f_{A}, where f_{A}≦0.2, preferably ≦0.15, especially ≦0.1, and J_{R} being the mass moment of inertia of the rotor (1) and s_{ges} being a speed distribution that is the ratio of the speed range of the differential drive (6) to the speed range of the rotor (1).

17. Energy production plant according to claim 1, wherein the nominal speed of the differential drive is ≧1000 min⁻¹, preferably ≧1250 min⁻¹, and especially ≧1500 min⁻¹.

18. Energy production plant according to claim 2, wherein the differential drive (6) is connected to the sun wheel (11) of the differential gear (11 to 13) and wherein the differential drive (6) is located on the side of the generator (8) facing away from the differential gear (11 to 13).
